(19) United States
(12) Patent Application Publication
(10) Pub. No.: US 2024/0220093 A1
(43) Pub. Date: Jul. 4, 2024

(54) CONTROL DEVICE FOR INDUSTRIAL MACHINE

(71) Applicant: Fanuc Corporation, Minamitsuru-gun, Yamanashi (JP)

(72) Inventor: Hideo Ogino, Minamitsuru-gun, Yamanashi (JP)

(73) Assignee: Fanuc Corporation, Minamitsuru-gun, Yamanashi (JP)

(21) Appl. No.: 18/289,147

(22) PCT Filed: May 25, 2021
(86) PCT No.: PCT/JP2021/019880

§ 371 Date: Nov. 1, 2023

(51) Int. Cl. G06F 3/04847; G05B 19/4155; G06F 3/04845; G06F 3/04886

(52) U.S. Cl. CPC G06F 3/04847; G05B 19/4155; G06F 3/04845; G06F 3/04886; G05B 2219/49108; G06F 2203/04808

(57) ABSTRACT

This control device includes an image display unit that displays, on a display screen, an operation image for changing an override value of a drive axis, a determination unit that determines the override value on the basis of an operation of the operation image, and a control unit that controls the drive axis on the basis of the override value determined by the determination unit.

### CROSS REFERENCE TO RELATED APPLICATIONS

This is the U.S. National Phase application of PCT/JP2021/019880, filed May 25, 2021, the disclosure of this application being incorporated herein by reference in its entirety for all purposes.

### FIELD OF THE INVENTION

The present disclosure relates to a controller for an industrial machine.

### BACKGROUND OF THE INVENTION

A control panel of a controller that controls an industrial machine is provided with an override switch that adjusts a rotational speed of a spindle and a feed rate of a feed axis (for example, Patent Document 1).

### PATENT DOCUMENT

Patent Document 1: JP 2019-63914 A

### SUMMARY OF THE INVENTION

However, when the control panel is provided with a dedicated override switch for adjusting each speed, manufacturing costs of the control panel increase.

An object of the disclosure is to provide a controller for an industrial machine that can reduce the manufacturing costs of the control panel.

A controller includes an image display unit configured to display an operation image for changing an override value of a driving axis on a display screen, a determination unit configured to determine the override value based on an operation on the operation image, and a control unit configured to control the driving axis based on the override value determined by the determination unit.

According to one aspect of the disclosure, it is possible to reduce costs of the control panel of the controller.

### BRIEF DESCRIPTION OF DRAWINGS

FIG. 1 is a block diagram illustrating an example of a hardware configuration of a controller;

FIG. 2 is a block diagram illustrating an example of functions of the controller;

FIG. 3 is a diagram illustrating an example of an actual speed image;

FIG. 4 is a diagram illustrating an example of an operation image;

FIG. 5 is a diagram for describing an example of an operation on the operation image;

FIG. 6 is a diagram for describing an example of an operation on the operation image;

FIG. 7 is a diagram for describing an example of an operation on the actual speed image and the operation image;

FIG. 8 is a flowchart illustrating an example of a flow of processing executed by a controller;

FIG. 9 is a diagram illustrating an example of an actual speed image;

FIG. 10 is a diagram illustrating an example of an operation image;

FIG. 11 is a diagram for describing an example of an operation on the operation image;

FIG. 12 is a diagram for describing an example of an operation on the operation image;

FIG. 13 is a diagram for describing an example of an operation on the actual speed image and the operation image;

FIG. 14 is a diagram illustrating an example of a display mode setting table;

FIG. 15 is a diagram illustrating an example of an increase/decrease range setting table; and

FIG. 16 is a diagram illustrating an example of an override value setting table.

### DETAILED DESCRIPTION OF EMBODIMENTS OF THE INVENTION

An embodiment of the disclosure will be described below with reference to the drawings. Note that not all combinations of features described in the following embodiment are necessarily required to solve the problem. In addition, more detailed description than necessary may be omitted. Further, the following description of the embodiment and drawings are provided for a full understanding of the disclosure by those skilled in the art and are not intended to limit the scope of the claims.

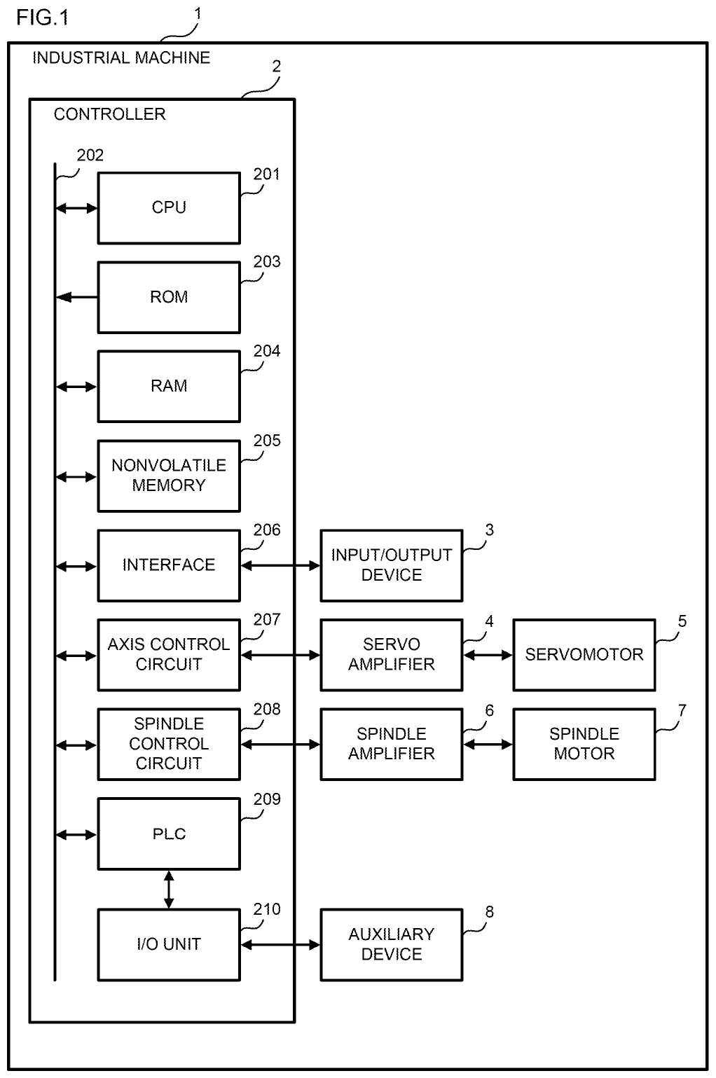

FIG. 1 is a diagram illustrating an example of a hardware configuration of an industrial machine. For example, the industrial machine 1 is a machine tool, a wire electric discharge machine, or a robot. The machine tool includes a lathe, a machining center, and a multi-tasking machine. For example, the robot is an industrial robot such as a manipulator.

The industrial machine 1 includes a controller 2, an input/output device 3, a servo amplifier 4 and a servomotor 5, a spindle amplifier 6 and a spindle motor 7, and an auxiliary device 8.

The controller 2 is a device that controls the entire industrial machine 1. The controller 2 is, for example, a numerical controller that controls the industrial machine 1. The controller 2 includes a CPU (Central Processing Unit) 201, a bus 202, a ROM (Read Only Memory) 203, a RAM (Random Access Memory) 204, and a nonvolatile memory 205.

The CPU 201 is a processor that controls the entire controller 2 according to a system program. The CPU 201 reads a system program, etc. stored in the ROM 203 via the bus 202 and performs various processes based on the system program. In addition, the CPU 201 controls the servomotor 5 and the spindle motor 7 based on a machining program.

For example, the CPU 201 analyzes the machining program and outputs control commands to the servomotor 5 and the spindle motor 7 for each control cycle.

The bus 202 is a communication path that connects respective pieces of hardware in the controller 2 to each other. The respective pieces of hardware in controller 2 exchange data via the bus 202.

The ROM 203 is a storage device that stores a system program, etc. for controlling the entire controller 2. The ROM 203 is a computer-readable storage medium.

The RAM 204 is a storage device that temporarily stores various data. The RAM 204 functions as a working area for the CPU 201 to process various data.

The nonvolatile memory 205 is a storage device that retains data even in a state in which the power of the industrial machine 1 is turned off and power is not supplied to the controller 2. The nonvolatile memory 205 stores, for example, a machining program and various parameters input from the input/output device 3. The nonvolatile memory 205 is a computer-readable storage medium. The nonvolatile memory 205 includes, for example, an SSD (Solid State Drive).

The controller 2 further includes an interface 206, an axis control circuit 207, a spindle control circuit 208, a PLC (Programmable Logic Controller) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. In addition, the input/output device 3 receives input of various data and transmits the various data to the CPU 201 via the interface 206. The input/output device 3 is, for example, a touch panel. When the input/output device 3 is a touch panel, the touch panel is, for example, a capacitive-type touch panel. Note that the touch panel is not limited to the capacitive type, and may be a touch panel of another type. The input/output device 3 is attached to, for example, a control panel (not illustrated) in which the controller 2 is stored.

The axis control circuit 207 is a circuit that controls the servomotor 5. The axis control circuit 207 receives a control command from the CPU 201 and outputs a command for driving the servomotor 5 to the servo amplifier 4. For example, the axis control circuit 207 transmits a torque command for controlling torque of the servomotor 5 to the servo amplifier 4.

The servo amplifier 4 receives a command from the axis control circuit 207 and supplies current to the servomotor 5.

The servomotor 5 is driven by being supplied with current from the servo amplifier 4. For example, the servomotor 5 is coupled to a ball screw that drives a tool post. By driving the servomotor 5, for example, a structure of the industrial machine 1 such as the tool post moves in an X-axis direction, a Y-axis direction, or a Z-axis direction. Note that the servomotor 5 may incorporate a speed detector (not illustrated) that detects a feed rate of each feed axis.

The spindle control circuit 208 is a circuit for controlling the spindle motor 7. The spindle control circuit 208 receives a control command from the CPU 201 and outputs a command for driving the spindle motor 7 to the spindle amplifier 6. For example, the spindle control circuit 208 transmits a torque command for controlling torque of the spindle motor 7 to the spindle amplifier 6.

The spindle amplifier 6 receives a command from the spindle control circuit 208 and supplies current to the spindle motor 7.

The spindle motor 7 is driven by being supplied with current from the spindle amplifier 6. The spindle motor 7 is coupled to the spindle and rotates the spindle.

The PLC 209 is a device that executes a ladder program to control the auxiliary device 8. The PLC 209 transmits a command to the auxiliary device 8 via the I/O unit 210.

The I/O unit 210 is an interface that connects the PLC 209 and the auxiliary device 8 to each other. The I/O unit 210 transmits a command received from the PLC 209 to the auxiliary device 8.

The auxiliary device 8 is a device that is installed in the industrial machine 1 and performs an auxiliary operation in the industrial machine 1. The auxiliary device 8 may be a device installed around the industrial machine 1. The auxiliary device 8 operates based on a command received from the I/O unit 210. The auxiliary device 8 is, for example, a tool changer, a cutting fluid injection device, or an opening/closing door driving device. Next, an example of functions of the controller 2 will be described.

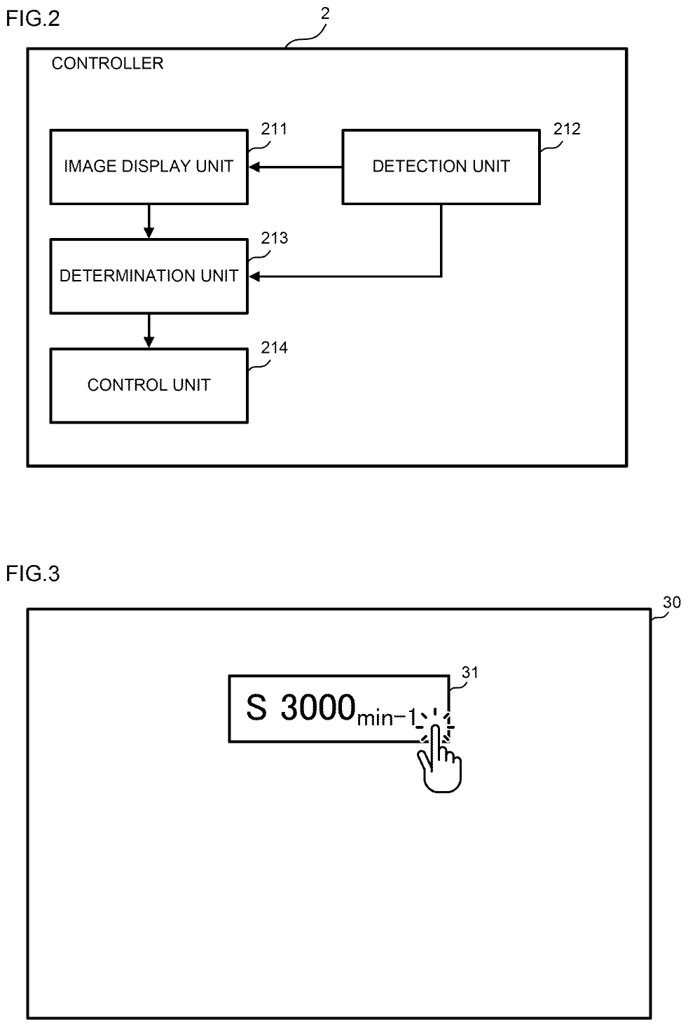

FIG. 2 is a block diagram illustrating an example of functions of the controller 2. The controller 2 includes an image display unit 211, a detection unit 212, a determination unit 213, and a control unit 214.

For example, the image display unit 211, the detection unit 212, the determination unit 213, and the control unit 214 are realized by the CPU 201 performing arithmetic processing using a system program stored in the ROM 203 and various data stored in the nonvolatile memory 205.

The image display unit 211 displays an actual speed image indicating an actual speed of a driving axis on a display screen. The driving axis is an axis for driving each unit of the industrial machine 1. The driving axis includes the spindle. In addition, the driving axis includes feed axes such as an X-axis, a Y-axis, and a Z-axis. Furthermore, the driving axis may include rotating axes such as an A-axis, a B-axis, and a C-axis. The actual speed is a speed at which the driving axis is actually driven. For example, the display screen is a display screen of the input/output device 3.

When the driving axis is the spindle, the actual speed of the driving axis is the rotational speed of the spindle. When the driving axis is the feed axis, the actual speed of the driving axis includes a cutting feed rate and a rapid traverse speed.

FIG. 3 is a diagram illustrating an example of the actual speed image displayed on the display screen. An actual speed image 31 illustrated in FIG. 3 is an image indicating the rotational speed of the spindle. The actual speed image 31 is displayed in a predetermined region of the display screen 30 of the input/output device 3. In FIG. 3, a figure simulating a hand indicates that the actual speed image 31 is touch-operated, and is not displayed on the display screen 30. Similarly, a figure simulating a hand drawn in each figure to be described later is not displayed on the display screen 30. In addition, illustration of an image other than the actual speed image 31 is omitted.

The detection unit 212 detects a touch operation on the display screen 30. For example, the detection unit 212 detects a touch operation on the actual speed image 31. The touch operation on the actual speed image 31 is an operation of touching the actual speed image 31. The touch operation on the actual speed image 31 may be an operation of touching the vicinity of the actual speed image 31 in addition to the operation of touching the actual speed image 31. Alternatively, the detection unit 212 may detect a touch operation on a predetermined position on the display screen 30.

The touch operation includes a tap operation, a long press operation, and a slide operation. In addition, the tap operation may be a plurality of tap operations. The touch operation is an operation using a finger of an operator. In addition, the touch operation may be an operation using a touch pen.

When the detection unit 212 detects a touch operation on the display screen 30, the image display unit 211 displays an operation image for changing an override value of the driving axis on the display screen 30. The override value is a ratio with respect to a command value when the command value is 100%, and is a value that changes the command value. For example, when a command value of the cutting feed rate is 1000 [mm/min], and the override value is set to 50%, an actual speed of cutting feed becomes 500 [mm/min].

When the detection unit 212 detects a touch operation on the actual speed image 31, the image display unit 211 displays an operation image adjacent to the actual speed image 31. In other words, the image display unit 211 displays the operation image and the actual speed image 31 side by side. In this case, the operation image and the actual speed image 31 may be displayed partially overlapping each other. Alternatively, one edge of the operation image and one edge of the actual speed image 31 may be displayed so as to be in contact with each other. Alternatively, the operation image and the actual speed image 31 may be separately displayed.

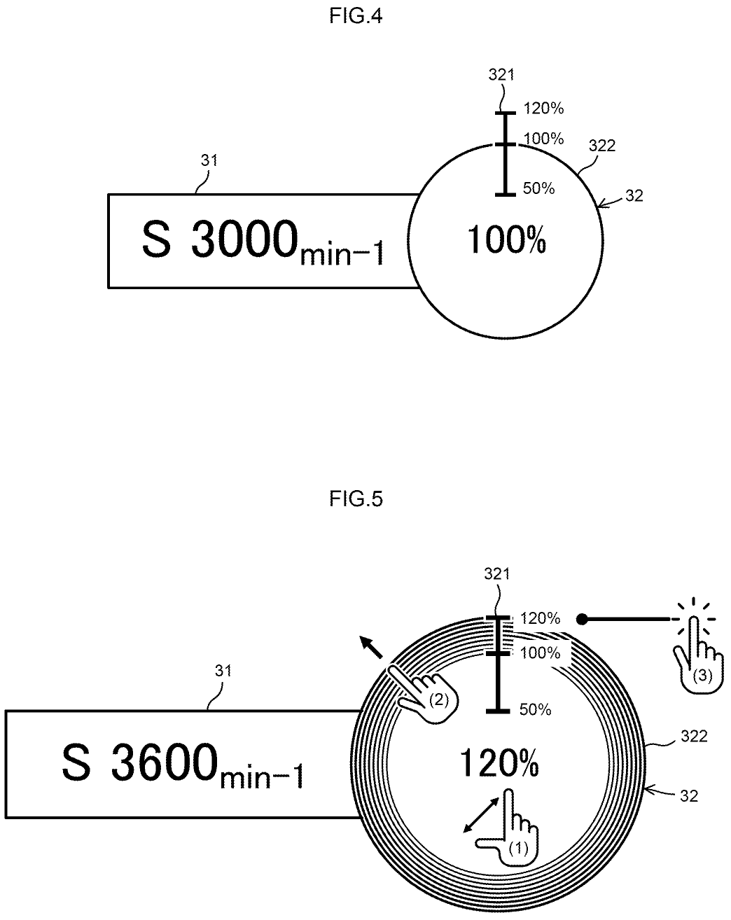

FIG. 4 is a diagram illustrating an example of the operation image. The operation image 32 includes a scale image 321 indicating the magnitude of the override value and an indication image 322 indicating a position in the scale image 321. In FIG. 4, an intersection of a circumference of a circular image and the scale image 321 indicates a current override value, that is, 100%. That is, in the example illustrated in FIG. 4, the circumference of the circular image is the indication image 322. Note that the current override value may be numerically indicated at a center of the circular image.

The determination unit 213 determines an override value of the driving axis based on an operation on the operation image 32.

FIG. 5 is a diagram for describing an example of an operation on the operation image 32. Operations of increasing the override value include (1) a pinch-out operation, (2) an operation of moving the indication image 322 toward a maximum value of the scale image 321, and (3) an operation of touching a maximum value display portion of the scale image 321.

The pinch-out operation is an operation in which two fingers are moved in a direction of being separated from each other in a state in which the fingers are in contact with the display screen 30. For example, when the operation on the operation image 32 is the pinch-out operation on the circular image, the determination unit 213 determines to increase the override value. Note that the determination unit 213 determines the amount of increase in the override value according to the amount of change in a distance between the two fingers. In addition, the image display unit 211 changes a position indicated by the indication image 322 in the scale image 321 according to the amount of increase in the override value. In the example illustrated in FIG. 5, an outer diameter of the circular image increases according to the amount of increase in the override value.

The operation of moving the indication image 322 toward the maximum value of the scale image 321 is, for example, an operation of sliding a finger outward in a radial direction of the circular image in a state in which the indication image 322 is touched by the finger. When the operation on the operation image 32 is the operation of moving the indication image 322 toward the maximum value of the scale image 321, the determination unit 213 determines to increase the override value. The determination unit 213 determines the amount of increase in the override value according to a slide distance of the finger in a state in which the indication image 322 is touched by the finger. In addition, the image display unit 211 changes the position indicated by the indication image 322 in the scale image 321 according to the amount of increase in the override value.

The operation of touching the maximum value display portion of the scale image 321 is, for example, an operation of touching a portion displaying the maximum value of the override value indicated by the scale image 321, or the vicinity of the portion displaying the maximum value. In the example illustrated in FIG. 5, the maximum value display portion is a portion displayed as “120%” and a region around the portion. When the operation on the operation image 32 is the operation of touching the maximum value display portion of the scale image 321, the determination unit 213 determines to increase the override value.

The determination unit 213 determines the amount of increase in the override value according to the number of taps on the maximum value display portion. For example, when the maximum value display portion is tapped once, the determination unit 213 determines to increase the override value by 10%. In addition, when the maximum value display portion is tapped twice, the determination unit 213 determines to increase the override value by 20%. Note that the determination unit 213 may determine the amount of increase in the override value according to a long press time of the maximum value display portion.

The image display unit 211 changes a position indicated by the indication image 322 in the scale image 321 according to the amount of increase in the override value. The image display unit 211 may change a display mode of the circular image along the radial direction according to the position indicated by the indication image 322 in the scale image 321. For example, as illustrated in FIG. 5, a region indicating the override value of 100% to 120% may be displayed so that a color continuously changes. In addition, the vicinity of a region indicating a maximum value 120% of the override value may be displayed in red, and the vicinity of a region indicating the override value 100% may be displayed in yellow. In this way, the operator can recognize whether or not the override value is being manipulated on a safe side by the color.

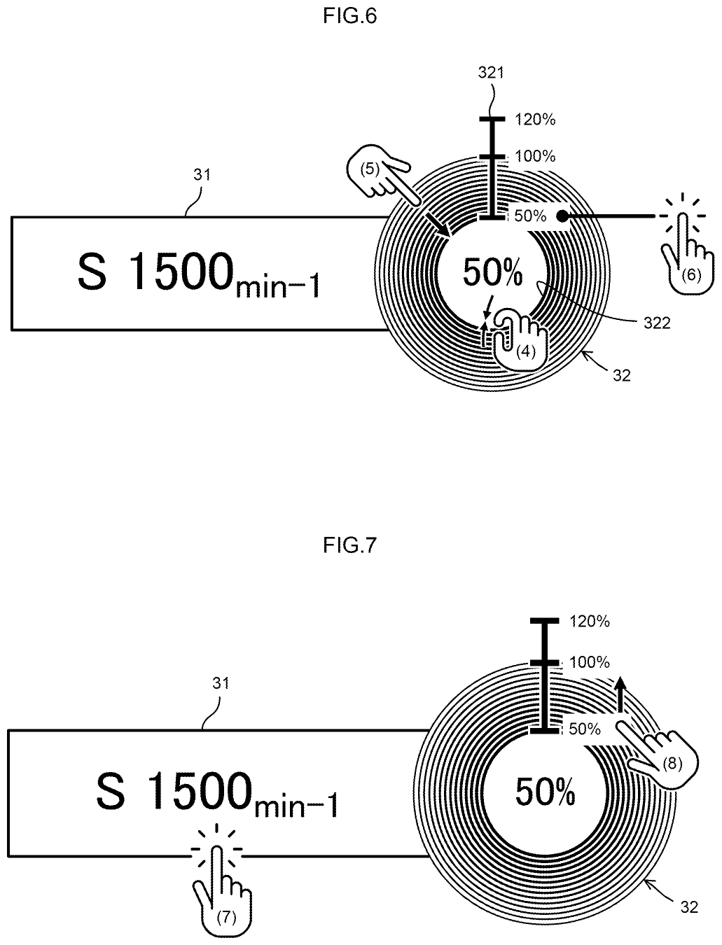

FIG. 6 is a diagram for describing an example of an operation on the operation image 32. For example, operations of decreasing the override value include (4) a pinch-in operation, (5) an operation of moving the indication image 322 toward a minimum value of the scale image 321, and (6) an operation of touching a minimum value display portion of the scale image 321.

The pinch-in operation is an operation in which two fingers are moved in a direction of approaching each other in a state in which the fingers are in contact with the display screen 30. For example, when the operation on the operation image 32 is the pinch-in operation on the circular image, the determination unit 213 determines to decrease the override value. Note that the determination unit 213 determines the amount of decrease in the override value according to the amount of change in a distance between the two fingers.

The image display unit 211 changes a position indicated by the indication image 322 in the scale image 321 according to the amount of decrease in the override value. In the example illustrated in FIG. 6, a circumference of the circular image decreases according to the amount of decrease in the override value. Here, the circumference refers to an inner diameter.

The operation of moving the indication image 322 toward the minimum value of the scale image 321 is, for example, an operation of sliding a finger inward in a radial direction of the circular image in a state in which the indication image 322 is touched by the finger. When the operation on the operation image 32 is the operation of moving the indication image 322 toward the minimum value of the scale image 321, the determination unit 213 determines to decrease the override value. The determination unit 213 determines the amount of decrease in the override value according to a slide distance of the finger in a state in which the indication image 322 is touched by the finger. In addition, the image display unit 211 changes the position indicated by the indication image 322 in the scale image 321 according to the amount of decrease in the override value.

The operation of touching the minimum value display portion of the scale image 321 is, for example, an operation of touching a portion displaying the minimum value of the override value indicated by the scale image 321, or the vicinity of the portion displaying the minimum value. In the example illustrated in FIG. 6, the minimum value display portion is a portion displayed as “50%” and a region around the portion. When the operation on the operation image 32 is the operation of touching the minimum value display portion of the scale image 321, the determination unit 213 determines to decrease the override value.

The determination unit 213 determines the amount of decrease in the override value according to the number of taps on the minimum value display portion. For example, when the minimum value display portion is tapped once, the determination unit 213 determines to decrease the override value by 10%. In addition, when the minimum value display portion is tapped twice, the determination unit 213 determines to decrease the override value by 20%. Note that the determination unit 213 may determine the amount of decrease in the override value according to a long press time of the minimum value display portion.

The image display unit 211 changes a position indicated by the indication image 322 in the scale image 321 according to the amount of decrease in the override value. The image display unit 211 may change a display mode of the circular image along the radial direction according to the position of the scale image 321 indicated by the indication image 322. For example, as illustrated in FIG. 6, a region indicating the override value of 100% to 50% may be displayed so that a color continuously changes. In addition, the vicinity of a region indicating a minimum value 50% of the override value may be displayed in blue, and the vicinity of a region indicating the override value 100% may be displayed in yellow. In this way, the operator can recognize whether or not the override value is being manipulated on a safe side by the color.

When conditions (7) to (9) described below are satisfied, the determination unit 213 determines to hide the operation image 32. When the determination unit 213 determines to hide the operation image 32, the image display unit 211 eliminates the operation image 32 from the display screen 30.

FIG. 7 is a diagram for describing an example of an operation on the actual speed image 31 and the operation image 32. For example, (7) when an operation is performed on the actual speed image 31 in a state in which the operation image 32 is displayed on the display screen 30, (8) when the operation on the operation image 32 is an operation of eliminating the operation image 32, or (9) when the operation on the operation image 32 is not detected for a predetermined time, the determination unit 213 determines to hide the operation image 32.

The operation on the actual speed image 31 is, for example, a tap operation, a long press operation, and a slide operation on the actual speed image 31. In addition, the operation of eliminating the operation image 32 is a flick operation on the operation image. The flick operation is an operation of rapidly moving a finger on the display screen 30, or an operation of flicking the display screen 30. Note that a direction of the flick operation may be any direction. A predetermine time is, for example, 20 seconds. That is, when there is no operation on the operation image 32 for 20 seconds, the determination unit 213 determines to hide the operation image 32.

The control unit 214 controls the driving axis based on the override value determined by the determination unit 213. The control unit 214 controls the feed axis in real time based on the override value determined by the determination unit 213.

Next, a description will be given of a flow of processing executed when controller 2 changes the override value.

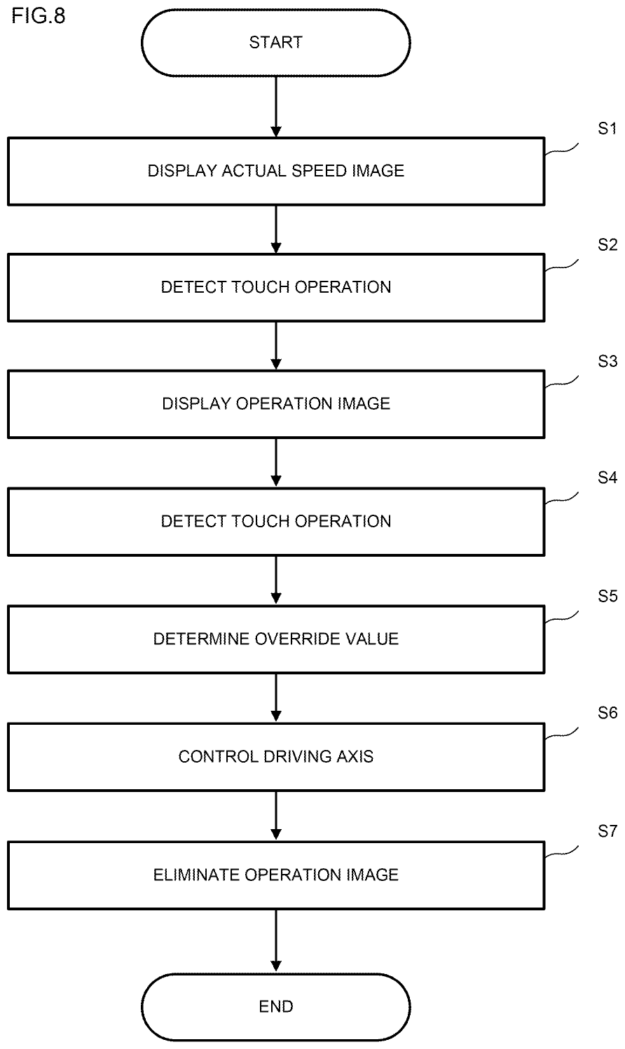

FIG. 8 is a flowchart illustrating an example of a flow of processing executed by the controller 2. First, when control by the controller 2 is started, the image display unit 211 displays the actual speed image 31 on the display screen 30 (step S1).

Next, when the operator performs a touch operation on the display screen 30, the detection unit 212 detects the touch operation on the display screen 30 (step S2). At this time, for example, the detection unit 212 detects a touch operation on the actual speed image 31.

Next, when the detection unit 212 detects a touch operation on the display screen 30, the image display unit 211 displays the operation image 32 on the display screen 30 (step S3).

Next, when the operator performs a touch operation on the operation image 32, the detection unit 212 detects the touch operation on the operation image 32 (step S4).

When the detection unit 212 detects a touch operation on the operation image 32, the determination unit 213 determines an override value based on the touch operation on the operation image 32 (step S5).

Next, the control unit 214 controls the driving axis based on the override value determined by the determination unit 213 (step S6).

When the touch operation for changing the override value ends, the image display unit 211 hides the operation image 32 (step S7) and ends the process.

As described above, the controller 2 includes the image display unit 211 that displays the operation image 32 for changing the override value of the driving axis on the display screen 30, the determination unit 213 that determines the override value based on the operation on the operation image 32, and the control unit 214 that controls the driving axis based on the override value determined by the determination unit 213.

Therefore, there is no need to provide a dedicated override switch for adjusting the speed of the driving axis on the control panel of the controller 2, and the manufacturing costs of the controller 2 can be reduced. In addition, the number of parts of the control panel can be reduced, assembly of the control panel is facilitated, and an assembly time of the control panel can be reduced. In addition, design changes of the display mode of the operation image 32, etc. can be facilitated. In this case, for example, the display mode can be designed according to a model of the industrial machine 1.

In addition, the controller 2 further includes the detection unit 212 that detects a touch operation on the display screen 30, and when the detection unit 212 detects a touch operation, the image display unit 211 displays the operation image 32 on the display screen 30. Therefore, the operation image 32 can be displayed on the display screen 30 only when the override value is needed to be manipulated. In other words, it is possible to prevent the display screen 30 from becoming overloaded with information and improve visibility of the display screen 30.

In addition, the image display unit 211 further displays the actual speed image 31 indicating the actual speed of the driving axis, and when the detection unit 212 detects a touch operation on the actual speed image 31, the image display unit 211 displays the operation image 32 on the display screen 30. In addition, the image display unit 211 displays the operation image 32 adjacent to the actual speed image 31. Therefore, the operator can visually recognize the actual speed image 31 and the operation image 32 at the same time. Alternatively, the operator does not have to significantly move a line of sight between the actual speed image 31 and the operation image 32. Therefore, it is possible to reduce the burden on the operator in manipulating the override of the driving axis.

In addition, when the detection unit 212 detects an operation on the actual speed image 31 in a state in which the operation image 32 is displayed on the display screen 30 or an operation of eliminating the operation image 32, or when the detection unit 212 does not detect an operation on the operation image 32 for a predetermined time, the determination unit 213 determines to hide the operation image 32. Therefore, when manipulation of the override value is unnecessary, visibility of the display screen 30 can be improved by hiding the operation image 32.

In addition, the determination unit 213 determines to increase the override value when the operation on the operation image 32 is the pinch-out operation, and determines to decrease the override value when the operation on the operation image 32 is the pinch-in operation. In addition, the operation image 32 includes the scale image 321 indicating the magnitude of the override value, and the indication image 322 indicating a position in the scale image 321, and the determination unit 213 determines to increase the override value when the operation on the operation image 32 is the operation of moving the indication image 322 toward the maximum value of the scale image 321, and determines to decrease the override value when the operation on the operation image 32 is the operation of moving the indication image 322 toward the minimum value of the scale image 321. In addition, the determination unit 213 determines to increase the override value when the operation on the operation image 32 is the operation of touching the maximum value display portion of the scale image 321, and determines to decrease the override value when the operation on the operation image 32 is the operation of touching the minimum value portion of the scale image 321. Therefore, the operator can change the override value through a simple operation.

In addition, the operation image 32 includes a circular image, and the indication image 322 is a circumferential portion of the circular image. In addition, the image display unit 211 changes a display mode of the circular image along the radial direction according to a position indicated by the indication image 322. Therefore, the operator can check the override value through an image other than the scale image. That is, visibility of the operation image 32 can be improved.

Next, a description will be given of an example of changing the override value of the feed rate of the feed axis. The feed rate of the feed axis includes a cutting feed rate and a rapid traverse speed.

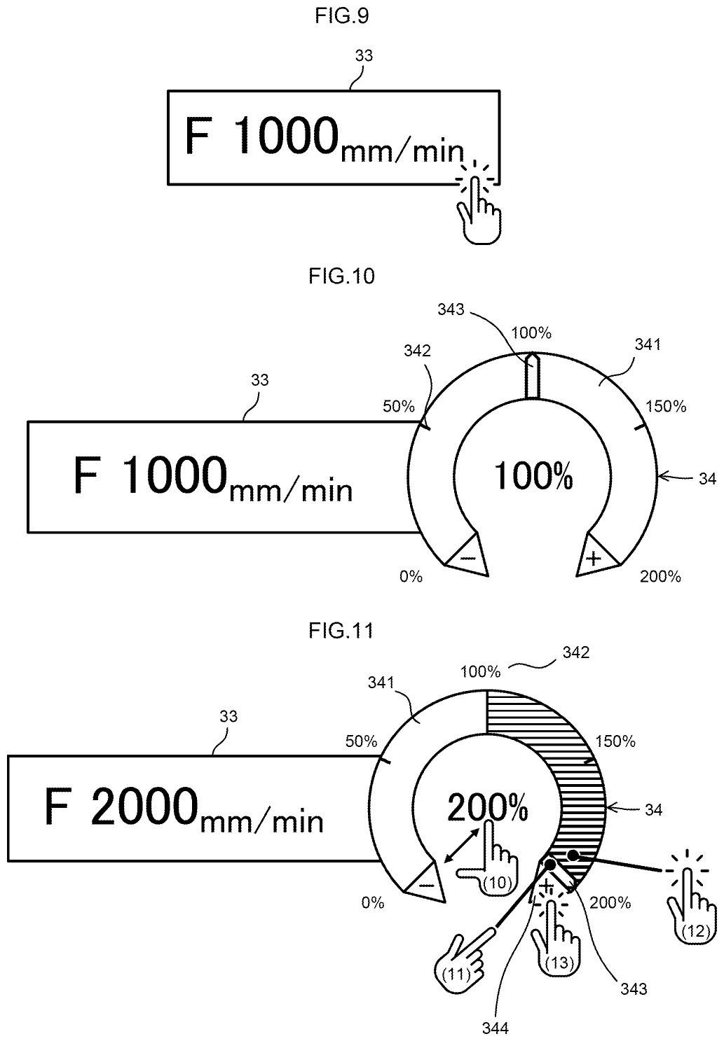

FIG. 9 is a diagram illustrating an example of the actual speed image. The actual speed image 33 illustrated in FIG. 9 is an image indicating an actual speed of a cutting feed rate of the feed axis. The actual speed image 33 is displayed in a predetermined range of the display screen 30 of the input/output device 3. For example, the detection unit 212 detects a touch operation on the actual speed image 33. When the detection unit 212 detects a touch operation on the actual speed image 33, the image display unit 211 displays an operation image for changing the override value of the driving axis on the display screen 30.

FIG. 10 is a diagram illustrating an example of an operation image. The operation image 34 includes an arc-shaped slide bar image 341, a scale image 342 indicating the magnitude of the override value, and an indication image 343 indicating a position in the scale image 342. In FIG. 10, the indication image 343 is an elongated pentagonal slider drawn at a position of 100%. Note that a current override value may be numerically indicated at a center of the slide bar image 341.

The determination unit 213 determines the override value of the driving axis based on an operation on the operation image 34.

FIG. 11 is a diagram for describing an example of the operation on the operation image 34. For example, operations of increasing the override value include (10) a pinch-out operation, (11) an operation of moving the indication image 343 toward a maximum value of the scale image 342, (12) an operation of touching a maximum value display portion of the scale image 342, and (13) an operation of touching an increase button 344 for increasing the override value.

When the operation on the operation image 34 is the pinch-out operation in the vicinity of the slide bar image 341, the determination unit 213 determines to increase the override value. The image display unit 211 changes a position indicated by the indication image 343 in the scale image 342 according to the amount of increase in the override value. In the example illustrated in FIG. 11, the indication image 343 moves toward a maximum value of the slide bar image 341 according to the amount of increase in the override value.

When the operation on the operation image 34 is the operation of moving the indication image 343 toward the maximum value of the scale image 342, the determination unit 213 determines to increase the override value. The determination unit 213 determines the amount of increase in the override value according to the position indicated by the indication image 343 in the scale image 342.

When the operation on the operation image 34 is the operation of touching the maximum value display portion of the scale image 342, the determination unit 213 determines to increase the override value. In the example illustrated in FIG. 11, the maximum value display portion of the scale image 342 is a portion displayed as “200%” and a region around the portion. For example, the determination unit 213 determines the amount of increase in the override value according to the number of taps on the maximum value display portion. The determination unit 213 may determine the amount of increase in the override value according to a long press time of the maximum value display portion. In addition, the image display unit 211 changes the position indicated by the indication image 343 in the scale image 342 according to the amount of increase in the override value.

When the operation on the operation image 34 is the operation of touching the increase button 344 for increasing the override value, the determination unit 213 determines to increase the override value. The operation of touching the increase button 344 includes an operation of tapping the increase button 344 and an operation of long-pressing the increase button 344. For example, the increase button 344 is displayed adjacent to the maximum value display portion of the slide bar image 341. In the example illustrated in FIG. 11, the increase button 344 is a triangular image displaying a character “+”.

The image display unit 211 may change a display mode of the slide bar image 341 along a longitudinal direction of the slide bar image 341 according to a position indicated by the indication image 343. For example, as illustrated in FIG. 11, a region indicating the override value of 100% to 200% may be displayed so that a color continuously changes. In addition, the vicinity of a region indicating a maximum value 200% of the override value may be displayed in red, and the vicinity of a region indicating the override value of 100% may be displayed in yellow. In this way, the operator can recognize whether or not the override value is being manipulated on a safe side by the color.

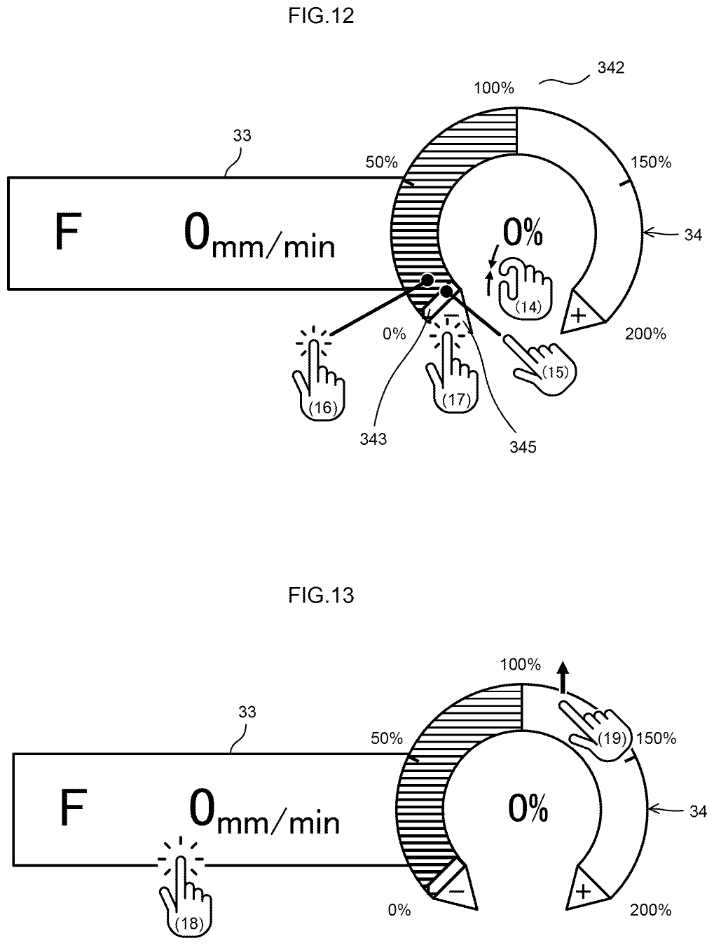

FIG. 12 is a diagram for describing an example of the operation on the operation image 34. For example, operations of decreasing the override value include (14) a pinch-in operation, (15) an operation of moving the indication image 343 toward a minimum value of the scale image 342, (16) an operation of touching a minimum value display portion of the scale image 342, and (17) an operation of touching a decrease button 345 for decreasing the override value.

For example, when the operation on the operation image 34 is the pinch-in operation in the vicinity of the slide bar image 341, the determination unit 213 determines to decrease the override value. The image display unit 211 changes a position indicated by the indication image 343 in the scale image 342 according to the amount of decrease in the override value. In the example illustrated in FIG. 12, the indication image 343 moves toward a minimum value of the slide bar image 341 according to the amount of decrease in the override value.

When the operation on the operation image 34 is the operation of moving the indication image 343 toward the minimum value of the scale image 342, the determination unit 213 determines to decrease the override value. The determination unit 213 determines the amount of decrease in the override value according to a slide distance of a finger in a state in which the indication image 343 is touched by the finger.

When the operation on the operation image 34 is the operation of touching the minimum value display portion of the scale image 342, the determination unit 213 determines to decrease the override value. In the example illustrated in FIG. 12, the minimum value display portion of the scale image 342 is a portion displayed as “0%” and a region around the portion. For example, the determination unit 213 determines the amount of decrease in the override value according to the number of taps on the minimum value display portion. In addition, the image display unit 211 changes the position indicated by the indication image 343 in the scale image 342 according to the amount of decrease in the override value. Note that the determination unit 213 may determine the amount of decrease in the override value according to a long press time of the minimum value display portion.

When the operation on the operation image 34 is the operation of touching the decrease button 345 for decreasing the override value, the determination unit 213 determines to decrease the override value. For example, the decrease button 345 is displayed adjacent to the minimum value display portion of the slide bar image 341. In the example illustrated in FIG. 12, the decrease button 345 is a triangular image displaying a character “−”.

The image display unit 211 may change a display mode along the longitudinal direction of the slide bar image 341 according to a position indicated by the indication image 343. For example, as illustrated in FIG. 12, a region indicating the override value of 100% to 0% may be displayed so that a color continuously changes. In addition, for example, the vicinity of a region indicating a minimum value of the override value may be displayed in blue.

Alternatively, the vicinity of a region indicating a minimum value 0% of the override value may be displayed in blue, and the vicinity of a region indicating the override value of 100% may be displayed in yellow. In this way, the operator can recognize whether or not the override value is being manipulated on a safe side by the color.

When conditions (18) to (20) described below are satisfied, the determination unit 213 determines to hide the operation image 34. When the determination unit 213 determines to hide the operation image 34, the image display unit 211 eliminates the operation image 34 from the display screen 30.

FIG. 13 is a diagram for describing an example of an operation on the actual speed image 33 and the operation image 34. For example, (18) when an operation is performed on the actual speed image 33 in a state in which the operation image 34 is displayed on the display screen 30, (19) when the operation on the operation image 34 is an operation of eliminating the operation image 34, or (20) when the operation on the operation image 34 is not detected for a predetermined time, the determination unit 213 determines to hide the operation image 34.

The operation on the actual speed image 33 is, for example, a tap operation, a long press operation, and a slide operation on the actual speed image 33. In addition, the operation of eliminating the operation image 34 is a flick operation on the operation image. The flick operation is an operation of rapidly moving a finger on the display screen 30, or an operation of flicking the display screen 30. Note that a direction of the flick operation may be any direction. A predetermine time is, for example, 20 seconds. That is, when there is no operation on the operation image 34 for 20 seconds, the determination unit 213 determines to hide the operation image 34.

In the embodiments described above, the color of the operation image 34 is continuously changed according to the override value. However, the color may be changed stepwise without being limited to a mode of being continuously changed. Alternatively, the color may be selected from a continuously changing mode and a stepwise changing mode. In this case, the controller 2 further includes a storage unit (not illustrated) and a reception unit (not illustrated).

The storage unit stores, for example, a display mode setting table in which a plurality of display modes of the operation image 34 is set. In addition, the reception unit receives a selection operation of selecting one display mode from the display mode setting table.

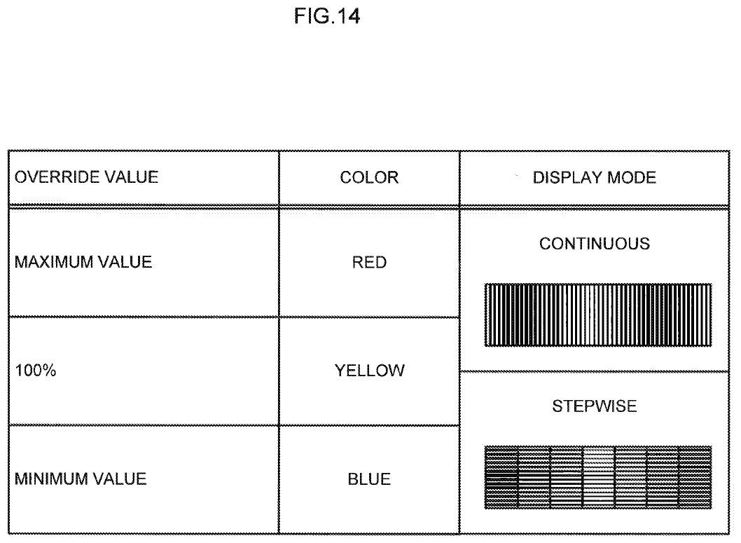

FIG. 14 is a diagram illustrating an example of the display mode setting table. In the display mode setting table, for example, a display mode of continuously changing the display mode and a display mode of changing the display mode stepwise of the operation image 32 or the operation image 34 are set. For example, the reception unit receives an operation of selecting a display mode. In this way, a display mode can be set according to preference of the operator.

In the embodiments described above, the override value increases or decreases by a predetermined percentage when one tap operation is performed. However, an increase range or a decrease range may be changed according to the number of tap operations. In this case, for example, the controller 2 includes an increase/decrease range setting table storage unit, and the increase/decrease range setting table storage unit stores an increase/decrease range setting table in which the number of tap operations is associated with an increase range and a decrease range.

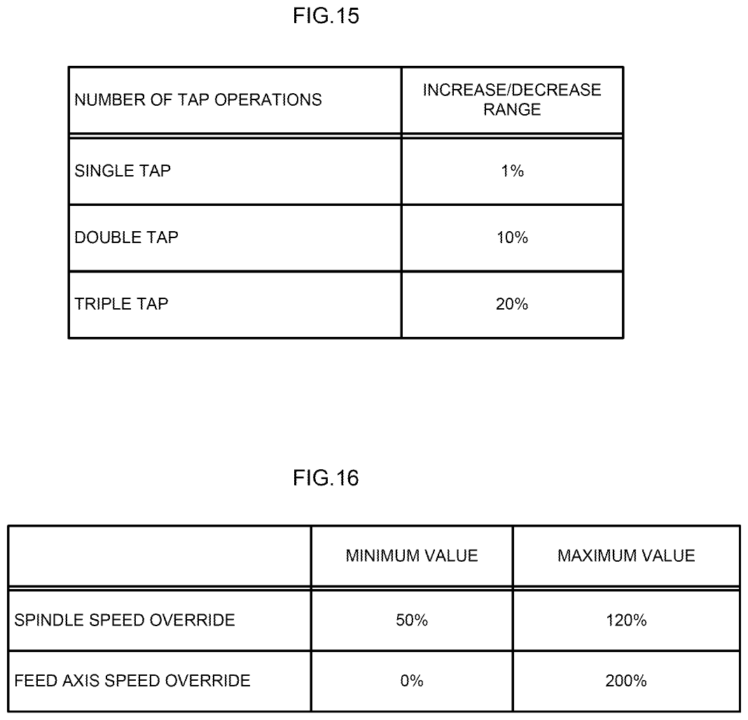

FIG. 15 is a diagram illustrating an example of the increase/decrease range setting table. In the increase/decrease range setting table, a single tap is associated with an increase/decrease range of 18, a double tap is associated with an increase/decrease range of 10%, and a triple tap is associated with an increase/decrease range of 20%. Therefore, when the maximum value display portion of the scale image 342 is tapped once, determination unit 213 determines to increase the override value by 1%. In addition, when the maximum value display portion of the scale image 342 is tapped twice in succession, the determination unit 213 determines to increase the override value by 10%. In addition, when the maximum value display portion of the scale image 342 is tapped three times in succession, the determination unit 213 determines to increase the override value by 20%. The determination unit 213 determines to decrease the override value by a similar decrease range when the minimum value display portion of the scale image 342 is tapped. Note that the controller 2 may include a reception unit, and the reception unit may receive an increase/decrease range set in the increase/decrease range setting table.

In addition, the controller 2 may include a storage unit, and the storage unit may store an override value setting table for setting a maximum value and a minimum value of the override value.

FIG. 16 is a diagram illustrating an example of the override value setting table. In the override value setting table, for example, a minimum value of 50% and a maximum value of 120% are set for the override value of the rotational speed of the spindle. In addition, a minimum value of 0% and a maximum value of 200% are set for the override value of the feed axis. Note that the controller 2 may include a reception unit, and the reception unit may receive a maximum value and a minimum value of each override value set in the override value setting table. In this case, the operator can set the override value according to an object to be machined, a machine tool, etc.

Note that the disclosure is not limited to the above embodiments, and can be modified as appropriate without departing from the scope of the disclosure. In the disclosure, modification of any component of the embodiments or omission of any component of the embodiments is possible.

### EXPLANATIONS OF LETTERS OR NUMERALS

1 INDUSTRIAL MACHINE
2 CONTROLLER
201 CPU
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
211 IMAGE DISPLAY UNIT
212 DETECTION UNIT
213 DETERMINATION UNIT
214 CONTROL UNIT
3 INPUT/OUTPUT DEVICE
30 DISPLAY SCREEN
31 ACTUAL SPEED IMAGE
32 OPERATION IMAGE
321 SCALE IMAGE
322 INDICATION IMAGE
33 ACTUAL SPEED IMAGE
34 OPERATION IMAGE
341 SLIDE BAR IMAGE
342 SCALE IMAGE
343 INDICATION IMAGE
344 INCREASE BUTTON
345 DECREASE BUTTON
4 SERVO AMPLIFIER
5 SERVOMOTOR
6 SPINDLE AMPLIFIER
7 SPINDLE MOTOR
8 AUXILIARY DEVICE

1. A controller comprising:
an image display unit configured to display an operation image for changing an override value of a driving axis on a display screen;
a determination unit configured to determine the override value based on an operation on the operation image; and
a control unit configured to control the driving axis based on the override value determined by the determination unit.

2. The controller according to claim 1, further comprising a detection unit configured to detect a touch operation on the display screen,
wherein, when the detection unit detects the touch operation, the image display unit displays the operation image on the display screen.

3. The controller according to claim 2, wherein:
the image display unit further displays an actual speed image indicating an actual speed of the driving axis on the display screen; and
when the detection unit detects the touch operation on the actual speed image, the image display unit displays the operation image on the display screen.

4. The controller according to claim 3, wherein the image display unit displays the operation image adjacent to the actual speed image.

5. The controller according to claim 3, wherein, when the detection unit detects an operation on the actual speed image or an operation of eliminating the operation image in a state in which the operation image is displayed on the display screen, or when the detection unit does not detect an operation on the operation image for a predetermined time, the determination unit determines to hide the operation image.

6. The controller according to claim 1, wherein the determination unit determines to increase the override value when the operation on the operation image is a pinch-out operation, and determines to decrease the override value when the operation on the operation image is a pinch-in operation.

7. The controller according to claim 1, wherein:
the operation image includes a scale image indicating magnitude of the override value and an indication image indicating a position in the scale image; and
the determination unit determines to increase the override value when the operation on the operation image is an operation of moving the indication image toward a maximum value of the scale image, and determines to decrease the override value when the operation on the operation image is an operation of moving the indication image toward a minimum value of the scale image.

8. The controller according to claim 7, wherein:
the operation image includes a circular image; and
the indication image is a circumference of the circular image.

9. The controller according to claim 8, wherein the image display unit changes a display mode of the circular image along a radial direction according to the position indicated by the indication image.

10. The controller according to claim 7, wherein:
the operation image includes a slide bar image; and
the image display unit changes a display mode of the slide bar image along a longitudinal direction of the slide bar image according to the position indicated by the indication image.

11. The controller according to claim 9, further comprising a storage unit configured to store a plurality of display modes,
wherein the display mode is one display mode among the plurality of display modes stored in the storage unit.

12. The controller according to claim 7, wherein the determination unit determines to increase the override value when the operation on the operation image is an operation of touching a maximum value display portion of the scale image, and determines to decrease the override value when the operation on the operation image is an operation of touching a minimum value display portion of the scale image.

13. The controller according to claim 12, wherein the determination unit determines an increase range of the override value based on the number of taps on the maximum value display portion, and determines a decrease range of the override value based on the number of taps on the minimum value display portion.

14. The controller according to claim 13, further comprising an increase/decrease range setting table storage unit configured to store an increase/decrease range setting table in which a relationship between the number of taps and the increase range and the decrease range of the override value is set.

15. The controller according to claim 1, wherein:
the operation image includes an increase button for increasing the override value and a decrease button for decreasing the override value; and
the determination unit determines to increase the override value when the operation on the operation image is an operation of touching the increase button, and determines to decrease the override value when the operation on the operation image is an operation of touching the decrease button.
